(19) United States
(12) Patent Application Publication
(10) Pub. No.: US 2019/0272628 A1
(43) Pub. Date: Sep. 5, 2019

(54) APPARATUS AND METHOD FOR ENHANCING OPTICAL FEATURE OF WORKPIECE, METHOD FOR ENHANCING OPTICAL FEATURE OF WORKPIECE THROUGH DEEP LEARNING, AND NON-TRANSITORY COMPUTER-READABLE RECORDING MEDIUM

(71) Applicant: UTECHZONE CO., LTD., New Taipei City (TW)

(72) Inventor: Chia-Chun TSOU, New Taipei City (TW)

(21) Appl. No.: 16/265,334

(22) Filed: Feb. 1, 2019

(30) Foreign Application Priority Data
Mar. 2, 2018 (TW) 107106952

(51) Int. Cl. G06T 7/00; H04N 5/235; G06T 5/20; G06K 9/62; G06K 9/78

(52) U.S. Cl. CPC G06T 7/0004; H04N 5/2354; G06T 5/20; G06K 9/6256; G06T 2207/20081; G06T 2207/10152; G06T 2207/30164; G06T 2207/10004; G06K 9/78

(57) ABSTRACT

The present invention provides an apparatus for enhancing an optical feature of a workpiece, comprising at least one variable image-taking device, at least one variable light source device, an image processing module and a control device. The variable image-taking device obtains images of the workpiece, and an external parameter and an internal parameter of which are adjustable. The variable light source device provides light source to the lighting the workpiece, wherein the variable light source device has an adjustable optical properties. The image processing module generates feature enhancement information according to the defect image information. The control device adjusts the external parameter, the internal parameter, and the optical properties according to the feature enhancement information and controls operations of the variable image-taking device and the variable light source device to obtain feature-enhanced images of the workpiece.

### BACKGROUND OF THE INVENTION

### 1. Technical Field

The present invention relates to an apparatus and method for enhancing the optical features of a workpiece, a method for enhancing the optical features of a workpiece through deep learning, and a non-transitory computer-readable recording medium. More particularly, the invention relates to an apparatus and method for enhancing the optical features of a workpiece by intensifying the defects or flaws detected from the workpiece, a method for achieving such enhancement through deep learning, and a non-transitory computer-readable recording medium for implementing the method.

### 2. Description of Related Art

Artificial intelligence (AI), also known as machine intelligence, refers to human-like intelligence demonstrated by a manmade machine via simulating such human abilities as reasoning, comprehension, planning, learning, interaction, perception, moving, and object operation. With the development of technology, AI-related research has had preliminary results, and AI nowadays is capable of better performance than humans particularly in areas involving a finite set of human abilities, such as in image recognition, speech recognition, and chess games.

Formerly, AI-based image analysis was carried out by machine learning, which involves analyzing image data and learning from the data in order to determine or predict the state of a target object. Later, the advancement of algorithms and the improvement of hardware performance brought about major breakthroughs in deep learning. For instance, with the help of artificial neural networks, human selection is no longer required in the machine training process of machine learning. Strong hardware performance and powerful algorithms make it possible to input images directly into an artificial neural network so that a machine can learn on its own. Deep learning is expected to gradually supersede machine learning and become the mainstream technique in machine vision and image recognition.

### BRIEF SUMMARY OF THE INVENTION

It is an objective of the present invention to increase the rate at which a convolutional neural network can recognize the defects of a workpiece. To this end, the defect features of images taken of a workpiece are optically enhanced, and the enhanced images are transferred to a deep-learning module to train the deep-learning module.

In order to achieve the above objective, the present invention provides an apparatus for enhancing an optical feature of a workpiece, wherein the apparatus receives the workpiece and corresponding defect image information from outside the apparatus, the apparatus comprising at least one variable image-taking device, at least one variable light source device, an image processing module and a control device. The image-taking device obtains images of the workpiece in a working area, wherein the variable image-taking device has an external parameter and an internal parameter, which are adjustable. The variable light source device provides light source to the workpiece in the working area, wherein the optical properties of the variable light source device is adjustable. The image processing module generates feature enhancement information according to the defect image information. The control device adjusts the external parameter, the internal parameter, and/or the optical properties according to the feature enhancement information and controlling operation of the variable image-taking device and/or of the variable light source device to obtain feature-enhanced images of the workpiece.

Another objective of the present invention is to provide a method for enhancing an optical feature of a workpiece, comprising the steps of: receiving the workpiece and corresponding defect image information from outside; moving the workpiece to a working area; generating feature enhancement information according to the defect image information; adjusting an optical properties of a variable light source device according to the feature enhancement information, and then providing light source to the workpiece in the working area by the variable light source device; and adjusting an external parameter and an internal parameter of a variable image-taking device according to the feature enhancement information, and then capturing images of the workpiece in the working area by the variable image-taking device to obtain feature-enhanced images of the workpiece.

Another objective of the present invention is to provide a method for enhancing an optical feature of a workpiece through deep learning, comprising the steps of: receiving the workpiece and corresponding defect image information from outside; moving the workpiece to a working area; generating feature enhancement information according to the defect image information; adjusting an optical properties of a variable light source device according to the feature enhancement information, and then providing light source to the workpiece in the working area by the variable light source device; adjusting an external parameter and an internal parameter of a variable image-taking device according to the feature enhancement information, and then capturing images of the workpiece in the working area by the variable image-taking device to obtain feature-enhanced images of the workpiece; normalizing the feature-enhanced images to form training samples; and providing the training samples to a deep-learning model and thereby training the deep-learning model to identify the defect image information

Furthermore, another objective of the present invention is to provide a non-transitory computer-readable recording medium, comprising a computer program, wherein the computer program performs the above methods after being loaded into and executed by a controller.

The present invention can effectively enhance the presentation of defects or flaws in the images of a workpiece, thereby increasing the rate at which a deep-learning model can recognize the defect or flaw features.

According to the present invention, images can be taken of a workpiece under different lighting conditions and then input into a deep-learning model in order for the model to learn from the images. This also helps increase the defect or flaw feature recognition rate of the deep-learning model.

### BRIEF DESCRIPTION OF THE SEVERAL VIEWS OF THE DRAWINGS

FIG. 1 is a block diagram of an optical feature enhancement system according to the invention.

FIG. 2 is a functional block diagram of the image processing module in the present invention.

FIG. 3 is a schematic diagram of the light source control module in the variable light source device of the present invention.

FIG. 4 is a schematic diagram of another preferred embodiment of the variable light source device of the present invention.

FIG. 5 is a schematic diagram of another preferred embodiment of the variable light source device of the present invention.

FIG. 6 is a perspective view of the variable image-taking device and movable platform thereof of the present invention.

FIG. 7 is a side view of the variable image-taking device and movable platform thereof of the present invention.

FIG. 8 is a block diagram showing how a convolutional neural network is trained.

FIG. 9 is the first parts of the flowchart of the disclosed method for enhancing the optical features of a workpiece.

FIG. 10 is the second parts of the flowchart of the disclosed method for enhancing the optical features of a workpiece.

### DETAILED DESCRIPTION OF THE INVENTION

The details and technical solution of the present invention are hereunder described with reference to accompanying drawings. For illustrative sake, the accompanying drawings are not drawn to scale. The accompanying drawings and the scale thereof are restrictive of the present invention.

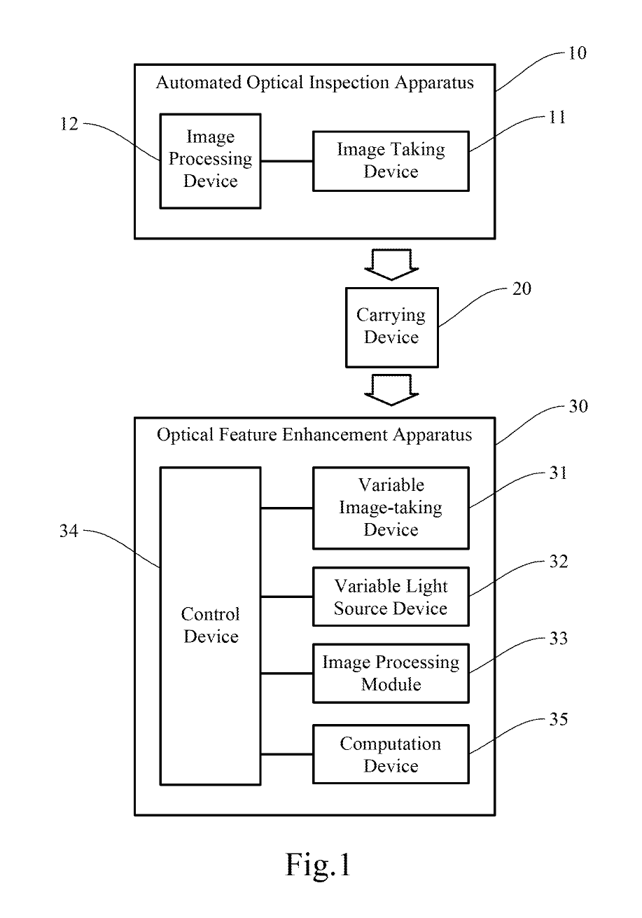

A preferred embodiment of the present invention is described below with reference to FIG. 1, which is a block diagram of an optical feature enhancement system according to the invention.

The invention essentially includes an automated optical inspection apparatus 10, at least one carrying device 20, and at least one optical feature enhancement apparatus 30. The carrying device 20 and the optical feature enhancement apparatus 30 are provided downstream of the automated optical inspection apparatus 10. A workpiece that has been inspected by the automated optical inspection apparatus 10 is carried by the carrying device 20 to the working area of the optical feature enhancement apparatus 30. The optical feature enhancement apparatus 30 provides additional lighting to enhance the defect features of the workpiece, and images thus obtained are output to a convolutional neural network (CNN) system to conduct training process.

The automated optical inspection apparatus 10 includes an image taking device 11 and an image processing device 12 connected to the image taking device 11. The image taking device 11 photographs a workpiece to obtain images of the workpiece. In a preferred embodiment, the image taking device 11 may be an area scan camera or a line scan camera; the present invention has no limitation in this regard. The image processing device 12 is configured to generate defect image information by analyzing and processing images. The defect image information includes such information as the types and/or locations of defects.

The carrying device 20 is provided downstream of the automated optical inspection apparatus 10 and is configured to carry a workpiece that has been inspected by the automated optical inspection apparatus 10 to the working area of the optical feature enhancement apparatus 30 in an automatic or semi-automatic manner. In a preferred embodiment, the carrying device 20 is composed of a plurality of working devices, and the working devices work in concert with one another to transfer workpieces along a relatively short or relatively good path, keeping the workpieces from collision or damage during the transferring or carrying process. More specifically, the carrying device 20 may be a conveyor belt, a linearly movable platform, a vacuum suction device, a multi-axis carrier, a multi-axis robotic arm, a flipping device, or the like, or any combination of the foregoing; the present invention has no limitation in this regard.

The optical feature enhancement apparatus 30 is also provided downstream of the automated optical inspection apparatus 10 and receives inspected workpieces from the carrying device 20. The optical feature enhancement apparatus 30 includes at least one variable image-taking device 31; at least one variable light source device 32; an image processing module 33; a control device 34 connected to the variable image-taking device 31, the variable light source device 32, and the image processing module 33; and a computation device 35 coupled to the control device 34. The variable light source device 32 and the variable image-taking device 31 are provided in a working area in order to provide auxiliary lighting to and take further images of a workpiece respectively.

The variable light source device 32 is configured to provide light source to a workpiece and has adjustable optical properties. More specifically, the adjustable optical properties of the variable light source device 32 may include the intensity, projection angle, or wavelength of the output light.

In a preferred embodiment, the variable light source device 32 can provide uniform light, collimated light, annular light, a point source of light, spotlight, area light, volume light, and so on. In another preferred embodiment, the variable light source device 32 includes a plurality of lamp units provided respectively at different positions and angles (e.g., one at the front, one at the back, and several lateral light sources positioned at different angles respectively), wherein the light sources of the light units at different corresponding angles can be selectively activated by instructions of the control device 34 in order to obtain images of a workpiece illuminated by different light sources, or wherein the lamp unit can be moved by movable platforms to different positions in order to provide multi-angle or partial lighting.

In yet another preferred embodiment, the variable light source device 32 can provide light of different wavelengths, such as white light, red light, blue light, green light, yellow light, ultraviolet (UV) light, and laser light, so that the defect features of a workpiece can be rendered more distinguishable by illuminating the workpiece with light of one of the wavelengths.

In still another preferred embodiment, and by way of example only, the variable light source device 32 can provide partial lighting to the defects of a workpiece according to instructions of the control device 34.

The variable image-taking device 31 is configured to obtain images of a workpiece and has external parameters and internal parameters, which are adjustable. The internal parameters include, for example, the focal length, the image distance, the position where a camera's center of projection lies on the images taken, the aspect ratio of the images taken (expressed in numbers of pixels), and a camera's image distortion parameters. The external parameters include, for example, the location and shooting direction of a camera in a three-dimensional coordinate system, such as a rotation matrix and a displacement matrix.

In a preferred embodiment, the variable image-taking device 31 may be an area scan camera or a line scan camera, depending on equipment layout requirements; the present invention has no limitation in this regard.

The image processing module 33 is configured to generate feature enhancement information based on the defect image information. More specifically, the feature enhancement information may be a combination of a series of control parameters, wherein the control parameters are generated according to the types and locations of defects and may be, for example, specific coordinates, a lighting strategy, or a process flow. In a preferred embodiment, a database of control parameters is established, and the desired control parameters can be found according to the types and locations of defects. The control parameters are output to the control device 34 in order for the control device 34 to adjust the output of the variable image-taking device 31 and of the variable light source device 32 in advance and/or in real time.

The control device 34 is configured to adjust the aforesaid external parameters, internal parameters, and/or optical properties according to the feature enhancement information and control the operation of the variable image-taking device 31 and/or of the variable light source device 32 so that feature-enhanced images can be obtained of a workpiece.

In a preferred embodiment, the control device 34 essentially includes a processor and a storage unit connected to the processor. In this embodiment, the processor and the storage unit may jointly form a computer or processor, such as a personal computer, a workstation, a mainframe computer, or a computer or processor of any other form; the present invention has no limitation in this regard. Also, the processor in this embodiment may be coupled to the storage unit. The processor may be, for example, a central processing unit (CPU), a programmable general-purpose or application-specific microprocessor, a digital signal processor (DSP), a programmable controller, an application-specific integrated circuit (ASIC), a programmable logic device (PLD), or any other similar device, or a combination of the above.

The computation device 35 is configured to execute a deep-learning model after loading the storage unit and then train the deep-learning model with feature-enhanced images so that the deep-learning model can identify defect image information. The deep-learning model may be but is not limited to a LeNet model, an AlexNet model, a GoogleNet model, a Visual Geometry Group (VGG) model, or a convolutional neural network based on (e.g., expanded from and with modifications made to) any of the aforementioned model.

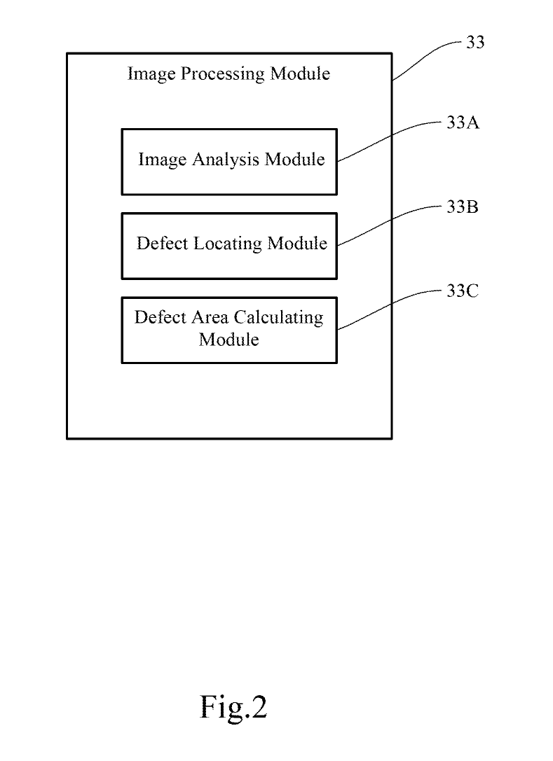

Reference is now made to FIG. 2, which is a functional block diagram of the image processing module in the present invention.

The automated optical inspection apparatus 10 takes images of a workpiece, marks the defect features of the images taken, and sends the defect image information to the image processing module 33 in order for the image processing module 33 to output feature enhancement information to the control device 34, thereby allowing the control device 34 to control the operation of the variable image-taking device 31 and/or of the variable light source device 32. The image processing module 33 includes the following parts, named after their respective functions: an image analysis module 33A, a defect locating module 33B, and a defect area calculating module 33C.

The image analysis module 33A is configured to verify the defect features and defect types by analyzing the defect image information. More specifically, the image analysis module 33A performs a pre-processing process (e.g., image enhancement, noise elimination, contrast enhancement, border enhancement, feature extraction, image compression, and image transformation) on an image obtained, applies a vision software tool and algorithm to the to-be-output image to accentuate the presentation of the defect features in the image, and compares the processed image of the workpiece with an image of a master slice to determine the differences therebetween, to verify the existence of the defects, and preferably to also identify the defect features and the defect types according to the presentation of the defects.

The defect locating module 33B is configured to locate the defect features of a workpiece, or more particularly to find the positions of the defect features in the workpiece. More specifically, after the image analysis module 33A verifies the existence of defects, the defect locating module 33B assigns coordinates to the location of each defect feature in the image, correlates each set of coordinates with the item number of the workpiece and the corresponding defect type, and stores the aforesaid information into a database for future retrieval and access. It is worth mentioning that distinct features of the workpiece or of the workpiece carrier can be marked as reference points for the coordinate system, or the boundary of the workpiece (in cases where the workpiece is a flat object such as a panel or circuit board) can be directly used to define the coordinate system; the present invention has no limitation in this regard.

The defect area calculating module 33C is configured to analyze the covering area of each defect feature in the workpiece. More specifically, once the type and location of a defect are known, it is necessary to determine the extent of the defect feature in the workpiece so that the backend optical feature enhancement apparatus 30 can take images covering the entire defect feature in the workpiece and determine the covering area to be enhanced. The defect area calculating module 33C can identify the extent of each defect feature by searching for the boundary values of connected sections and then calculate the area of the defect feature in the workpiece.

Any defect feature obtained through the foregoing procedure by the image processing module 33 includes such information as the type and/or location of the defect.

As defect features present themselves better with certain types of light sources than with others, the control device 34 of the optical feature enhancement apparatus 30 refers to the types of the defect features detected (as can be found in the feature enhancement information obtained, which includes such information as the types and location of the defects) in order to determine which type of light source should be provided to the workpiece in the working area.

The storage unit of the control device 34 is prestored with a database that includes indices and output values corresponding respectively to the indices. After obtaining the feature enhancement information from the image processing module 33, the control device 34 uses the feature enhancement information as an index to find the corresponding output value, which is subsequently used to adjust the optical properties of the variable light source device 32.

The relationship between defect types and the optical properties of the variable light source device 32 is described below by way of example. Please note that the following examples demonstrate only certain ways of implementing the present invention and are not intended to be restrictive of the scope of the invention.

If a defect feature provides a marked contrast in hue, color saturation, or brightness to the surrounding area and can be easily identified through an image processing procedure (e.g., binarization), it is feasible to provide the workpiece surface with uniform light (or ambient light) so that every part of the visible surface of the workpiece has the same brightness. Such defect features include, for example, metal discoloration, discoloration of the workpiece surface, black lines, accumulation of ink, inadvertently exposed substrate areas, bright dots, variegation, dirt, and scratches.

If a defect feature is an uneven area in the image, it is feasible to provide the workpiece surface with collimated light from the side so that an included angle is formed between the optical path and the visible surface of the workpiece, allowing the uneven area in the image to cast a shadow. Such defect features include vertical lines, blade streaks, sanding marks, and other uneven workpiece surface portions.

If a defect feature is a flaw inside the workpiece or can reflect light of a particular wavelength, it is feasible to provide a backlight at the back of the workpiece or illuminate the workpiece with a light source whose wavelength can be adjusted to accentuate the defect in the image. Such defect features include, for example, mura, bright dots, and bright sub-pixels.

Aside from the above, different light source combinations can be used to highlight different defect features in an image. The resulting feature-enhanced images (i.e., images in which the defect features have been accentuated) are sent to the deep-learning model in the computation device 35 to train the model and thereby raise the recognition rate of the model.

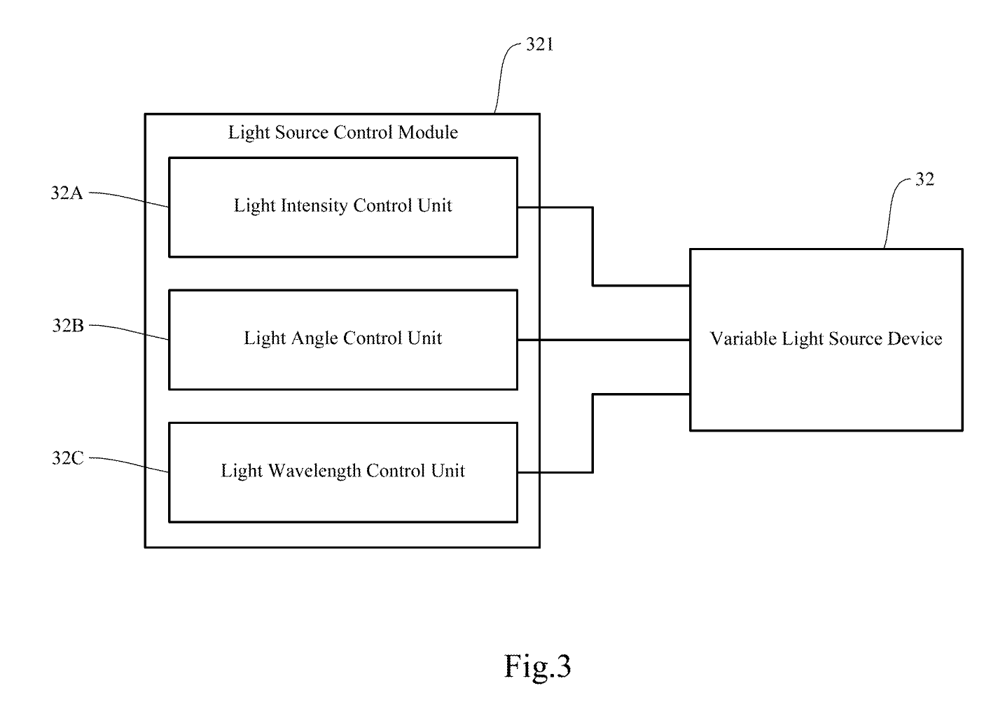

The following paragraphs describe various embodiments of the variable light source device 32 with reference to FIG. 3, which is a schematic diagram of the light source control module in the variable light source device of the present invention.

According to a preferred embodiment as shown in FIG. 3, the variable light source device 32 is composed of a plurality of lamp units, and the operation of the lamp units is controlled by a light source control module 321 connected or coupled to the lamp units. More specifically, the light source control module 321 includes a light intensity control unit 32A, a light angle control unit 32B, and a light wavelength control unit 32C.

The light intensity control unit 32A is configured to control the output power of one or a plurality of lamp units. The optical feature enhancement apparatus 30 can detect the state of ambient light and then control the output power of the lamp units of the variable light source device 32 through the light intensity control unit 32A according to the detection result.

The light angle control unit 32B is configured to control the light projection angles of the lamp units. In a preferred embodiment, the lamp units are directly set at different angles to target the working area, and the light angle control unit 32B will turn on the lamp units whose positions correspond to instructions received from the control device 34. In another preferred embodiment, carrying devices are provided to carry the lamp units of the variable light source device 32 to the desired positions to shed additional light on a workpiece. In yet another preferred embodiment, the polarization property of each lamp unit can be changed via an electromagnetic transducer module provided on an optical propagation medium, with a view to outputting light of different phases or polarization directions. The present invention has no limitation on how the light angle control unit 32B is implemented.

The light wavelength control unit 32C is configured to control the variable light source device 32 to output light so that the defects on the surface of a workpiece can be accentuated by switching to a certain wavelength. Light provided by the variable light source device 32 includes, for example, white light, red light, blue light, green light, yellow light, UV light, and laser light. The aforementioned light can be used to accentuate mura defects of a panel and defects that are hidden in a workpiece but easily identifiable with particular light.

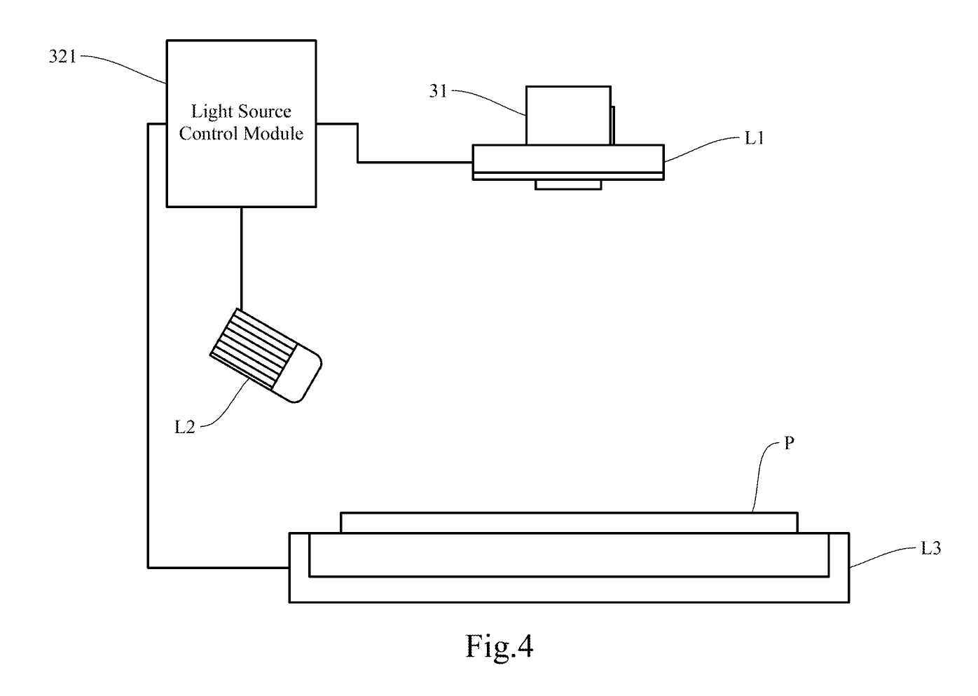

Please refer to FIG. 4 for a schematic diagram of another preferred embodiment of the variable light source device of the present invention.

As shown in FIG. 4, the light source control module 321 in this preferred embodiment can be connected to a plurality of different lamp units in order for the lamp units to output different types of light sources in response to different defect features. In this embodiment, the light source control module 321 is connected to an annular light L1, a sidelight L2, and a backlight L3. Based on instructions received from the control device 34, the light source control module 321 determines the light(s) to be turned on so that the corresponding light will be output to the workpiece P, allowing the variable image-taking device 31 to obtain images of the workpiece P under that particular light.

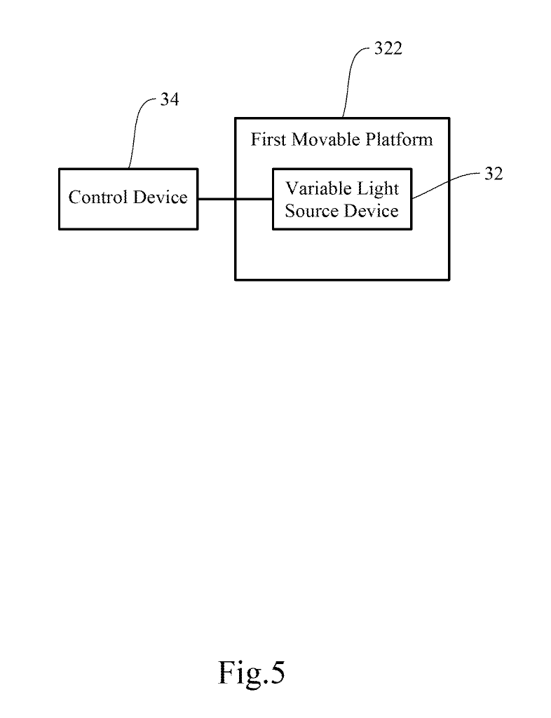

Please refer to FIG. 5 for a schematic diagram of yet another preferred embodiment of the variable light source device of the present invention.

As shown in FIG. 5, the optical feature enhancement apparatus 30 further includes a first movable platform 322 for carrying the variable light source device 32. The first movable platform 322 can move the variable light source device 32 within the working area according to instructions of the control device 34, thereby adjusting the optical properties of the variable light source device 32. This embodiment can be used to partially enhance certain areas of a workpiece and increase the contrast between the defect features of the workpiece and the surrounding areas so that images of the defect features stand out from the images taken.

The first movable platform 322 in this preferred embodiment may be a multidimensional linearly movable platform, a multi-axis robotic arm, or the like; the present invention has no limitation in this regard.

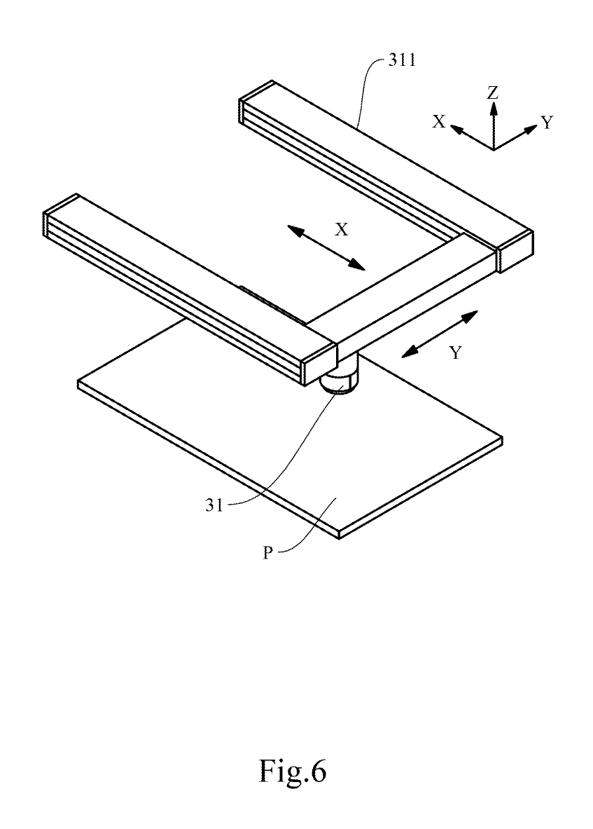

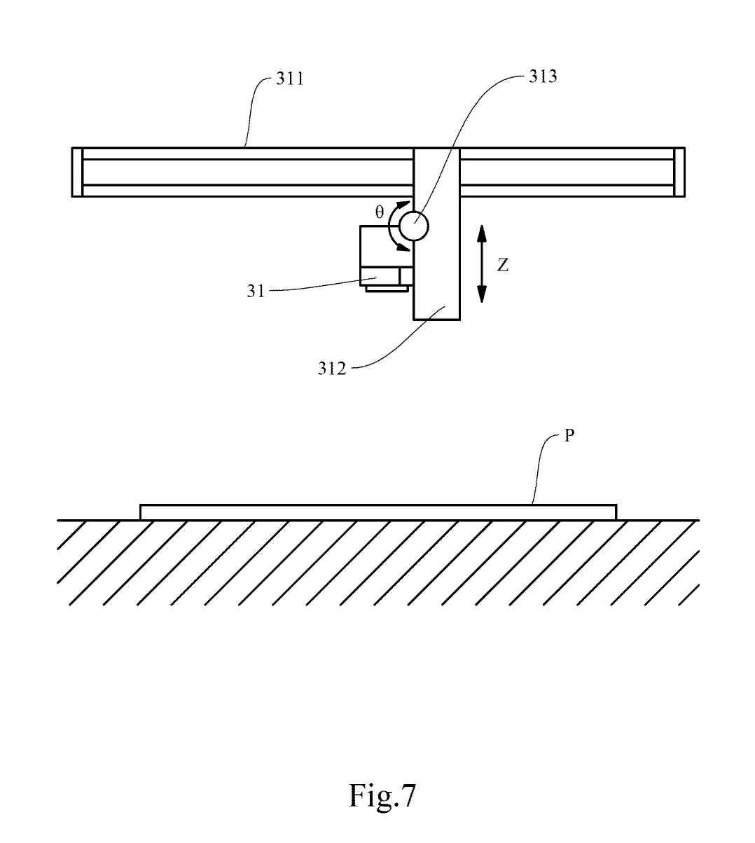

The following paragraphs describe various embodiments of the variable image-taking device 31 with reference to FIG. 6, which is a perspective view of the variable image-taking device and a second movable platform of the present invention, and FIG. 7, which is a side view of the variable image-taking device and the second movable platform in FIG. 6.

In the preferred embodiment shown in FIG. 6 and FIG. 7, the variable image-taking device 31 can adapt to the types or locations of the defects of the workpiece P by being moved according to instructions of the control device 34 to a better image-taking position or angle from or at which the variable image-taking device 31 can obtain images of the workpiece P. The optical feature enhancement apparatus 30 further includes a second movable platform 311 for carrying the variable image-taking device 31. The second movable platform 311 can move the variable image-taking device 31 within the working area to adjust the external parameters and internal parameters of the variable image-taking device 31, thereby enabling the variable image-taking device 31 to photograph the workpiece P in the optimal manner and produce enhanced images of the defects. The second movable platform 311 in this embodiment is a multidimensional linearly movable platform configured to be moved in the X, Y, Z, and θ directions so as to adjust the relative positions of, and the distance and angle between, the variable image-taking device 31 and the workpiece P.

As shown in FIG. 6, the variable image-taking device 31 can be moved by the linearly movable platform along the X and Y directions. After receiving the location information of the defect features, the control device 34 controls the amounts by which the linearly movable platform is to be moved in the X and Y directions respectively, and the variable image-taking device 31 will be moved accordingly and thus aimed at the defect features in order to photograph the defect features.

In addition to moving the variable image-taking device 31 in the X and Y directions, the linearly movable platform can control the position and image-taking angle of the variable image-taking device 31 in the Z direction. As shown in FIG. 7, the linearly movable platform can optionally be provided with a lifting device 312 and a rotating device 313. The lifting device 312 is configured to move upward and downward with respect to the linearly movable platform, thereby adjusting the distance between the variable image-taking device 31 and the workpiece P. The rotating device 313 is configured to carry the variable image-taking device 31, and the rotation angle θ of the rotating device 313 is determined by instructions received from the control device 34 and defines the image-taking angle of the variable image-taking device 31.

Other than the foregoing methods, the control device 34 may adjust the focus and image-taking position of the variable image-taking device 31 via software or by an optical means in order to obtain feature-enhanced images; the present invention has no limitation on the control method of the control device 34.

The apparatus described above will eventually obtain feature-enhanced images, i.e., images in which the defect features are enhanced. The feature-enhanced images obtained will be normalized and then output to the deep-learning model in the computation device 35 to train the model. Structurally speaking, the deep-learning model may be a LeNet model, an AlexNet model, a GoogleNet model, or a VGG model; the present invention has no limitation in this regard.

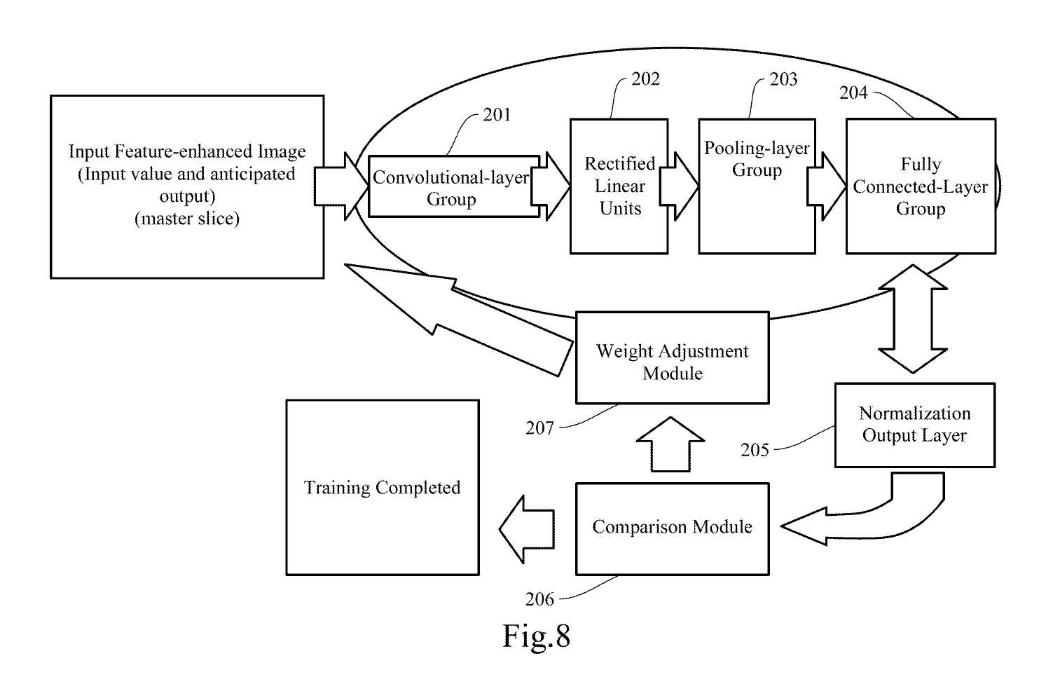

The training method of a convolutional neural network is described below with reference to FIG. 8, which is a block diagram showing how a convolutional neural network is trained.

As shown in FIG. 8, feature-enhanced images obtained from the foregoing process are input into a computer device (e.g., the computation device 35). The computer device uses the feature-enhanced images sequentially in a training process. Each feature-enhanced image includes two types of parameters, namely input values input into the network (i.e., image data) and an anticipated output (e.g., non-defective, NG, defective, or other defect types). The input values go through the convolutional-layer group 201, the rectified linear units 202, and the pooling-layer group 203 of the convolutional neural network repeatedly for feature enhancement and image compression and are classified by the fully connected-layer group 204 according to weights, before the classification result is output from the normalization output layer 205. A comparison module 206 compares the classification result (i.e., inspection result) with the anticipated output and determines whether the former matches the latter. If no, the comparison module 206 outputs the errors (i.e., differences) to a weight adjustment module 207 in order to adjust the weights of the fully connected layers by backpropagation. The steps described above are repeated until the training is completed.

The aforesaid process not only can increase the defect or flaw feature recognition rate of the convolutional neural network effectively, but also verifies the performance of the network repeatedly during the inspection process so that the trained device will eventually have a high degree of completion and a high recognition rate.

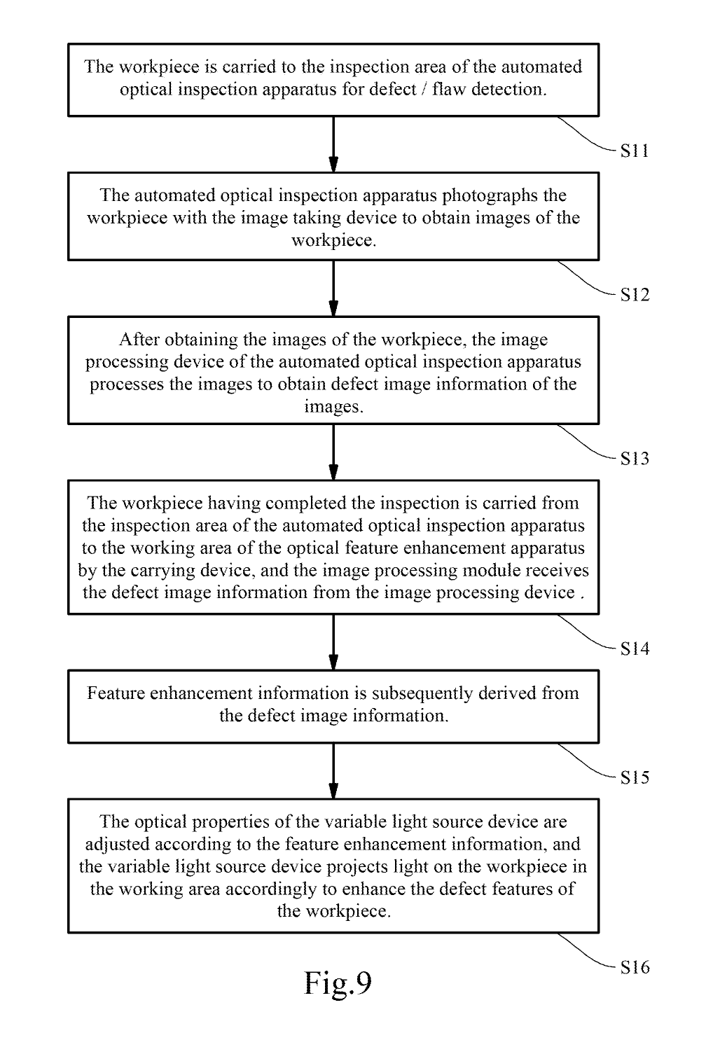

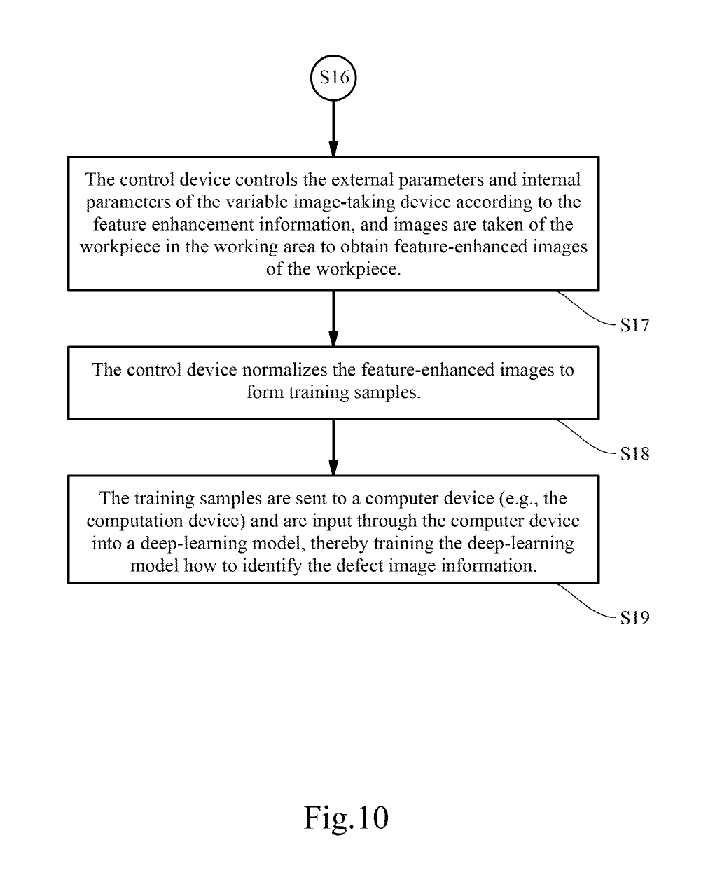

The method of the present invention for enhancing the optical features of a workpiece is described below with reference to FIG. 9 and FIG. 10, which are respectively the first and second parts of the flowchart of the disclosed method for enhancing the optical features of a workpiece.

As shown in FIG. 9 and FIG. 10, the disclosed method for enhancing the optical features of a workpiece essentially includes the following steps:

To begin with, the workpiece is carried to the inspection area of the automated optical inspection apparatus 10 for defect/flaw detection (step S11).

Then, the automated optical inspection apparatus 10 photographs the workpiece with the image taking device 11 to obtain images of the workpiece (step S12).

After obtaining the images of the workpiece, the image processing device 12 of the automated optical inspection apparatus 10 processes the images to obtain defect image information of the images (step S13). The defect image information includes such information as the types and/or locations of defects.

The workpiece having completed the inspection is carried from the inspection area of the automated optical inspection apparatus 10 to the working area of the optical feature enhancement apparatus 30 by the carrying device 20, and the image processing module 33 receives the defect image information from the image processing device 12 (step S14).

Feature enhancement information is subsequently derived from the defect image information (step S15). The feature enhancement information may be a combination of a series of control parameters, wherein the control parameters are generated according to the types and locations of the defects.

After that, the optical properties of the variable light source device 32 are adjusted according to the feature enhancement information, and the variable light source device 32 projects light on the workpiece in the working area accordingly to enhance the defect features of the workpiece (step S16). More specifically, the optical properties of the variable light source device 32 are adjusted according to the types of the defects, and the adjustable optical properties of the variable light source device 32 include the intensity, projection angle, or wavelength of the light source.

Following that, the control device 34 controls the external parameters and internal parameters of the variable image-taking device 31 according to the feature enhancement information, and images are taken of the workpiece in the working area to obtain feature-enhanced images of the workpiece (step S17). More specifically, the control device 34 can adjust, among others, the position, angle, or focal length of the variable image-taking device 31 according to the types of the defects.

Then, the control device 34 normalizes the feature-enhanced images to form training samples (step S18). Each training sample at least includes input values and an anticipated output corresponding to the input values.

The training samples are sent to a computer device (e.g., the computation device 35) and are input through the computer device into a deep-learning model, thereby training the deep-learning model how to identify the defect image information (step S19).

The steps stated above can be carried out by way of a non-transitory computer-readable recording medium. Such a computer-readable recording medium may be, for example, a read-only memory (ROM), a flash memory, a floppy disk, a hard disk drive, an optical disc, a USB flash drive, a magnetic tape, a database accessible through a network, or any other storage medium that a person skilled in the art can easily think of as having similar functions.

In summary, the present invention can effectively enhance the presentation of defects or flaws in the images of a workpiece, thereby increasing the rate at which a deep-learning model can recognize the defect or flaw features. In addition, according to the present invention, images can be taken of a workpiece under different lighting conditions and then input into a deep-learning model in order for the model to learn from the images. This also helps increase the defect or flaw feature recognition rate of the deep-learning model.

The above is the detailed description of the present invention. However, the above is merely the preferred embodiment of the present invention and cannot be the limitation to the implement scope of the present invention, which means the variation and modification according the present invention may still fall into the scope of the invention.

What is claimed is:

1. An apparatus for enhancing an optical feature of a workpiece, wherein the apparatus receives the workpiece and corresponding defect image information from outside the apparatus, the apparatus comprising:
at least one variable image-taking device for obtaining images of the workpiece in a working area, wherein the variable image-taking device has an external parameter and an internal parameter, which are adjustable;
at least one variable light source device for lighting the workpiece in the working area, wherein the variable light source device has an adjustable optical properties;
an image processing module for generating feature enhancement information according to the defect image information; and
a control device for adjusting the external parameter, the internal parameter, and/or the optical properties according to the feature enhancement information and controlling operation of the variable image-taking device and/or of the variable light source device to obtain feature-enhanced images of the workpiece.

2. The apparatus of claim 1, further comprising a computation device coupled to the control device, wherein the computation device is configured to execute a deep-learning model after loading a storage unit, and to identify the defect image information according to the feature-enhance images.

3. The apparatus of claim 2, wherein the deep-learning model is a LeNet model, an AlexNet model, a GoogleNet model or a Visual Geometry Group (VGG) model.

4. The apparatus of claim 1, wherein the adjustable optical properties of the variable light source device include intensity, projection angle, or wavelength of the light source.

5. The apparatus of claim 4, wherein the variable light source device includes a plurality of lamp units provided respectively at different positions and angles.

6. The apparatus of claim 4, wherein the light provided by the variable light source device includes white light, red light, blue light, green light, yellow light, ultraviolet (UV) light, or laser light.

7. The apparatus of claim 4, wherein the variable light source device comprises a plurality of lamp units and a light source control module connected or coupled to the plurality of lamp units.

8. The apparatus of claim 7, wherein the light source control module includes:
a light intensity control unit configured to control an output power of one or a plurality of lamp units;
a light angle control unit configured to control light projection angles of the lamp units; and,
a light wavelength control unit configured to control the variable light source device to output light of different wavelengths.

9. The apparatus of claim 1, wherein the defect image information received by the image processing module includes types and/or locations of defects.

10. The apparatus of claim 1, further comprising one or a plurality of carrying device, configured to carry the workpiece that has been inspected by an outer automated optical inspection apparatus to the working area.

11. The apparatus of claim 10, wherein the carrying device comprises a conveyor belt, a linearly movable platform, a vacuum suction device, a multi-axis carrier, a multi-axis robotic arm, or a flipping device.

12. The apparatus of claim 1, further comprising a first movable platform for carrying the variable light source device; wherein the first movable platform moves the variable light source device within the working area, thereby adjusting the optical properties of the variable light source device.

13. The apparatus of claim 12, wherein the first movable platform is a multidimensional linearly movable platform or a multi-axis robotic arm.

14. The apparatus of claim 1, further comprising a second movable platform for carrying the variable image-taking device; wherein the second movable platform moves the variable image-taking device within the working area to adjust the external parameters and the internal parameters of the variable image-taking device.

15. The apparatus of claim 1, wherein the image processing module includes:
an image analysis module configured to verify defect features and defect types by analyzing the defect image information;
a defect locating module configured to locate the defect features of the workpiece to find the positions of the defect features in the workpiece; and,
a defect area calculating module configured to analyze a covering area of the defect features in the workpiece.

16. A method for enhancing an optical feature of a workpiece, comprising the steps of:
receiving the workpiece and corresponding defect image information from outside;
moving the workpiece to a working area;
generating feature enhancement information according to the defect image information;
adjusting an optical properties of a variable light source device according to the feature enhancement information, and then lighting the workpiece in the working area by the variable light source device; and
adjusting an external parameter and an internal parameter of a variable image-taking device according to the feature enhancement information, and then capturing images of the workpiece in the working area by the variable image-taking device to obtain feature-enhanced images of the workpiece.

17. The method of claim 16, further comprising the step: providing the feature enhancement information to a deep-learning model, and then training the deep-learning model to identify the defect image information.

18. The method of claim 17, wherein the step of training include:
inputting the obtained feature-enhanced images into a computation device in order for the computation device uses the feature-enhanced images sequentially in a training process; wherein each said feature-enhanced image comprises two types of parameters consisting of input value and an anticipated output, wherein the input value is input into a convolutional neural network;
processing the input values of each said feature-enhanced image repeatedly by a convolutional-layer group, a rectified linear unit, and a pooling-layer group of the convolutional neural network to achieve feature enhancement and image compression;
classifying the processed input values of each said feature-enhanced image by a fully connected-layer group of the convolutional neural network according to weights, and outputting a classification result of each said feature-enhanced image by a normalization output layer of the convolutional neural network as an inspection result;
comparing the inspection result and the anticipated output of each said feature-enhanced image by a comparison module to determine whether the inspection result matches the anticipated output; and
outputting errors to a weight adjustment module and adjusting the weights of the fully connected-layer group through backpropagation, by the comparison module if the inspection result does not match the anticipated output.

19. The method of claim 16, wherein the step of adjusting the optical properties of the variable light source device includes adjusting intensity, projection angle, or wavelength of the light source.

20. The method of claim 16, wherein the step of adjusting the external parameter and the internal parameter of the variable image-taking device include adjusting an image-taking position, a focus position, or a focal length of the variable image-taking device.

21. The method of claim 16, wherein the step of generating feature enhancement information according to the defect image information further comprising:
analyzing the defect image information to verify defect features and defect types;
locating the defect features of a workpiece to find the positions of the defect features in the workpiece; and,
analyzing covering area of the defect features in the workpiece.

22. A method for enhancing an optical feature of a workpiece through deep learning, comprising the steps of:
receiving the workpiece and corresponding defect image information from outside;
moving the workpiece to a working area;
generating feature enhancement information according to the defect image information;
adjusting an optical properties of a variable light source device according to the feature enhancement information, and then lighting the workpiece in the working area by the variable light source device;
adjusting an external parameter and an internal parameter of a variable image-taking device according to the feature enhancement information, and then capturing images of the workpiece in the working area by the variable image-taking device to obtain feature-enhanced images of the workpiece;
normalizing the feature-enhanced images to form training samples; and
providing the training samples to a deep-learning model and thereby training the deep-learning model to identify the defect image information.

23. A non-transitory computer-readable recording medium, comprising a computer program, wherein the computer program performs the method of claim 16 after being loaded into and executed by a controller.
